(19) United States
(12) Patent Application Publication
(10) Pub. No.: US 2025/0087800 A1
(43) Pub. Date: Mar. 13, 2025

(54) POWER STORAGE DEVICE AND METHOD OF MANUFACTURING THE POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yozo UCHIDA, Toyota-shi (JP); Yuki SATO, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/744,702

(22) Filed: Jun. 17, 2024

(30) Foreign Application Priority Data
Sep. 12, 2023 (JP) 2023-147807

(51) Int. Cl. H01M 50/188; H01M 10/0525; H01M 50/15; H01M 50/193

(52) U.S. Cl. CPC H01M 50/188; H01M 10/0525; H01M 50/15; H01M 50/193; H01M 2220/20

(57) ABSTRACT

A power storage device includes a case lid member, a terminal member, and a resin member. The resin member includes a resin outer portion, a resin inner portion, and a resin inside-hole portion. The case lid member and the resin member are configured that, when the power storage device is placed under a temperature environment of −40° C., the resin member forms an outward convex warp in a lid thickness direction with respect to a lid longitudinal direction so that a pair of longitudinal joint faces of the resin inner portion press the terminal member in the lid longitudinal direction.

### CROSS-REFERENCE TO RELATED APPLICATIONS

This application is based upon and claims the benefit of priority from the prior Japanese Patent Application No. 2023-147807 filed on Sep. 12, 2023, the entire contents of which are incorporated herein by reference.

### TECHNICAL FIELD

The present disclosure relates to a power storage device in which a terminal member is fixed via a resin member to a case lid member that constitutes a case, and also relates to a method of manufacturing the power storage device.

### RELATED ART

As a power storage device, a battery is known in which positive and negative terminal members are fixed via respective resin members to a case lid member in the shape of a rectangular plate that constitutes a case of a parallelepiped box-like shape. Specifically, each of the positive and negative terminal members is inserted through an insertion hole formed in the case lid member, to extend from the inside of the case to the outside, and the resin member is hermetically joined to the case lid member and the terminal member while insulating these members from each other, to fix the terminal member to the case lid member. This type of battery is, for example, disclosed in JP Patent Application Publication No. 2022-079172.

### SUMMARY

### Technical Problems

In the above-mentioned battery, when the battery is placed under an environment at extremely low temperature such as −40° C., cracks may form due to cohesive failure along the boundary between the resin member and the terminal member in a region of the resin member close to the boundary. Specifically, the resin member includes a resin outer portion located on an outer side in a lid thickness direction of the case lid member, a resin inner portion located on an inner side in the lid thickness direction of the case lid member, and a resin inside-hole portion placed inside an insertion hole of the case lid member and integrally connected to the resin outer portion and the resin inner portion. Further, a joint face of the resin inner portion joined to the terminal member has a pair of longitudinal joint faces facing a lid longitudinal direction and a pair of transverse joint faces facing a lid transverse direction. Then, it has been confirmed that, in a region close to the pair of longitudinal joint faces of the resin inner portion, the above cracks form in each of the longitudinal joint faces.

Formation of the cracks is caused because a convex warp is formed on the resin member on an inner side in a lid thickness direction with respect to the lid longitudinal direction (hereinafter, only referred to the “inward convex warp on the inner side” or “convex warp on the inner side”). Occurrence of such an inward convex warp on the inner side of the resin member causes deformation of the resin inner portion to be separated away from the terminal member with respect to the lid longitudinal direction, and the cracks are considered to be formed due to generation of the cohesive failure in respective vicinities of the pair of longitudinal joint faces.

The present disclosure has been made in view of the above circumstances and provides a power storage device in which cracks are hard to be formed in a region close to a pair of longitudinal joint faces in a resin inner portion of a resin member even when the power storage device is placed under a low temperature environment of −40° C. and a method of manufacturing the power storage device.

### Means of Solving the Problems

(1) One aspect of the present disclosure to solve the above problem is to provide a power storage device comprising: a case lid member having an insertion hole and extending in a lid longitudinal direction; a terminal member inserted through the insertion hole of the case lid member; and a resin member hermetically joined to the case lid member and the terminal member while insulating the case lid member and the terminal member from each other, to fix the terminal member to the case lid member, wherein the resin member comprises: a resin outer portion located on an outer side in a lid thickness direction of the case lid member; a resin inner portion located on an inner side in the lid thickness direction of the case lid member, and a resin inside-hole portion located inside the insertion hole of the case lid member and integrally connected to the resin outer portion and the resin inner portion, the terminal member extends to an inner side in the lid thickness direction through the resin outer portion, the resin inside-hole portion, and the resin inner portion, the resin inner portion of the resin member includes a pair of longitudinal joint faces that face the lid longitudinal direction and is joined to the terminal member, the case lid member and the resin member are configured that, when the power storage device is placed under a temperature environment of −40° C., an outward convex warp in the lid thickness direction is formed in the resin member with respect to the lid longitudinal direction, and the pair of the longitudinal joint faces of the resin inner portion press the terminal member in the lid longitudinal direction, respectively.

According to the above power storage device, when the device is placed under a low temperature environment of −40° C., the resin member forms an outward convex warp in the lid thickness direction with respect to the lid longitudinal direction (hereinafter, just referred as the “outward convex warp” or “convex warp on the outer side”) on the contrary to the above. Then, the pair of the longitudinal joint faces of the resin inner portion respectively press the terminal member in the lid longitudinal direction. Accordingly, formation of cracks due to cohesive failure in a region close to the pair of longitudinal joint faces of the resin inner portion can be inhibited. Therefore, in the above-mentioned power storage device, even when the power storage device is placed at the low temperature of −40° C., cracks are hardly formed in the region close to the pair of longitudinal joint faces of the resin inner portion of the resin member.

Examples of the “power storage device” include secondary batteries such as a lithium-ion secondary battery, a sodium-ion secondary battery, and a calcium-ion secondary battery, and capacitors such as a lithium-ion capacitor.
(2) In the power storage device according to the above (1), preferably, the resin member has a volume V1 of the resin outer portion larger than a volume V2 of the resin inner portion (V1>V2).

In a case where the volume V2 of the resin inner portion is larger than the volume V1 of the resin outer portion of the resin member (V1<V2), when the power storage device is placed at a low temperature of −40° C., the resin member tends to easily cause an inward convex warp in the resin member. To address this, in the above power storage device, the volume V1 of the resin outer portion of the resin member is made larger than the volume V2 of the resin inner portion (V1>V2), so that a power storage device forming an outward convex warp in the resin member at the low temperature of −40° C. can be easily configured.
(3) The power storage device according to any one of the above (1) or (2), preferably, the terminal member includes a terminal seal portion to which the resin member is hermetically joined, and terminal nanocolumns with a height of 50 nm or more derived from metal that forms the terminal member and formed by joining particles of a diameter of 100 nm or less, together like strings of beads into the form of columns, stand numerously on a surface of the terminal seal portion, and the resin member is hermetically joined to the terminal seal portion with the resin material, which forms the resin member and fills gaps between the terminal nanocolumns standing numerously.

In the above-mentioned power storage device, the terminal nanocolumns described above stand together in large numbers on the surface of the terminal seal portion of the terminal member, and the gaps between the terminal nanocolumns are filled with the resin material, so that the resin member is hermetically joined to the terminal seal portion. With this arrangement, the joint strength of the terminal seal portion of the terminal member and the resin member can be increased, and a good seal between the terminal member and the resin member can be maintained.

The “particles derived from the metal that forms the terminal member”, which constitute the terminal nanocolumns, include particles made of the metal mentioned above, particles made of oxides of the above metal, and particles made of the above metal and the oxides of the above metal. Alternatively, the particles may be particles including nitrides of the above metal such as the particles made of the metal mentioned above, oxides of the above metal, and nitrides of the above metal.

The “terminal seal portion” may be provided in an entirety of the terminal joint portion to be joined to the resin member or may be provided partly in the terminal joint portion in the terminal member.
(4) Another aspect of the present disclosure is a method of manufacturing a power storage device comprising: a case lid member having an insertion hole and extending in a lid longitudinal direction; a terminal member inserted through the insertion hole of the case lid member; and a resin member hermetically joined to the case lid member and the terminal member while insulating the case lid member and the terminal member from each other, to fix the terminal member to the case lid member, wherein the resin member comprises: a resin outer portion located on an outer side in a lid thickness direction of the case lid member; a resin inner portion located on an inner side in the lid thickness direction of the case lid member; and a resin inside-hole portion located inside the insertion hole of the case lid member and integrally connected to the resin outer portion and the resin inner portion, wherein the terminal member extends to an inner side in the lid thickness direction through the resin outer portion, the resin inside-hole portion, and the resin inner portion, the resin inner portion of the resin member includes a pair of longitudinal joint faces that face the lid longitudinal direction and are joined to the terminal member, the case lid member and the resin member are configured that, when the power storage device is placed under a temperature environment of −40° C., an outward convex warp in the lid thickness direction is formed with respect to the lid longitudinal direction in the resin member, and the pair of the longitudinal joint faces of the resin inner portion press the terminal member in the lid longitudinal direction, respectively, wherein the method includes insert molding the resin member while the terminal member is inserted through the insertion hole of the case lid member.

In the above method of manufacturing the power storage device, the resin member is insert molded in the process of insert molding, and thus a power storage device forming the outward convex warp in the resin member at the low temperature of −40° C. as mentioned above can be easily manufactured.
(5) The method of manufacturing the power storage device according to the above (4), preferably, the insert molding is to mold the resin member in which a volume V1 of the resin outer portion is larger than a volume V2 of the resin inner portion (V1>V2).

In the above method of manufacturing the power storage device, the resin member in which the volume V1 of the resin outer portion is larger than the volume V2 of the resin inner portion is formed, and thus the power storage device in which the resin member forms the above-mentioned outward convex warp at the low temperature of −40° C. can be easily manufactured.
(6) The method of manufacturing the power storage device in the above (4) or (5), preferably, the terminal member includes a terminal seal portion to which the resin member is hermetically joined, and terminal nanocolumns with a height of 50 nm or more derived from metal that forms the terminal member and formed by joining particles of a diameter of 100 nm or less, together like strings of beads into the form of columns, stand numerously on a surface of the terminal seal portion, and the resin member is hermetically joined to the terminal seal portion with the resin material, which forms the resin member and fills gaps between the terminal nanocolumns standing numerously, the method further includes: terminal nanocolumn forming of applying a pulse oscillation laser beam to the terminal seal portion of the terminal member while shifting an irradiation position, to form the terminal nanocolumns standing numerously on the terminal seal portion before the insert molding, wherein the insert molding comprises molding the resin member while filling gaps between the terminal nanocolumns standing numerously on the terminal seal portion with the resin material.

According to the method of manufacturing the power storage device described above, the terminal nanocolumns described above are formed on the surface of the terminal seal portion by applying the laser beam to the surface as described above in the terminal nanocolumn forming. Thus, the terminal nanocolumns can be easily formed on the terminal seal portion. Then, the resin member is molded with the resin material filling gaps between the terminal nanocolumns in the insert molding, and thus, the joint strength of the terminal seal portion of the terminal member and the resin member can be increased, and a good seal can be maintained between the terminal member and the resin member.

### BRIEF DESCRIPTION OF THE DRAWINGS

FIG. 1 is a perspective view of a battery in an embodiment;

FIG. 2 is a partially broken cross-sectional view of the battery according to the embodiment, taken along a battery height direction and a battery width direction;

FIG. 3A is a partially enlarged plan view of a region close to the resin member that fixes the terminal member to the case lid member in the embodiment, when seen from an outer side in a lid thickness direction;

FIG. 3B is a partially enlarged plan view of the region close to the resin member that fixes the terminal member to the case lid member in the embodiment, when seen from an inner side in the lid thickness direction;

FIG. 4A is a partially enlarged cross-sectional view of a region close to the resin member that fixes the terminal member to the case lid member, which view is taken along an arrow 4A-4A in FIG. 3A along a lid longitudinal direction and the lid thickness direction;

FIG. 4B is a partially enlarged cross-sectional view of a region close to the resin member that fixes the terminal member to the case lid member, which view is taken along an arrow 4B-4B in FIG. 3A along a lid transverse direction and the lid thickness direction;

FIG. 5 is a partially enlarged cross-sectional view of terminal nanocolumns (lid nanocolumns) standing numerously on a surface of a terminal seal portion (a lid seal portion) in the embodiment;

FIG. 6A is an explanatory view showing the resin member and others when the battery according to the embodiment is placed at a low temperature of −40° C., corresponding to the cross-sectional view of FIG. 4A;

FIG. 6B is an explanatory view showing the resin member and others when the battery according to the embodiment is placed at the low temperature of −40° C., corresponding to the plan view of FIG. 3B;

FIG. 7 is a flow chart of a method of manufacturing the battery according to the embodiment;

FIG. 8 is an explanatory view illustrating a terminal nanocolumn formation process (lid nanocolumn formation process) in connection with the method of manufacturing the battery according to the embodiment;

FIG. 9A is an explanatory view of an insert molding process in which the terminal members are inserted through insertion holes of the case lid member, in connection with the method of manufacturing the battery according to the embodiment;

FIG. 9B is an explanatory view of the insert molding process in which the resin members are molded, in connection with the method of manufacturing the battery according to the embodiment;

FIG. 10A is an explanatory view illustrating the resin member and others when a battery is placed at the low temperature of −40° C. according to a comparative embodiment, corresponding to the explanatory view of FIG. 6A; and

FIG. 10B is an explanatory view illustrating the resin member and others when the battery is placed at the low temperature of −40° C. according to the comparative embodiment, corresponding to the explanatory view of FIG. 6B.

### DETAILED DESCRIPTION OF THE EXEMPLARY EMBODIMENTS

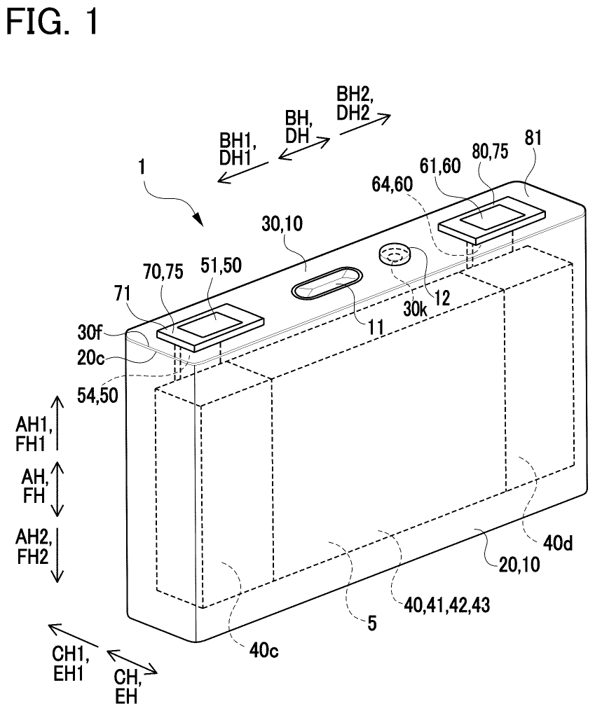

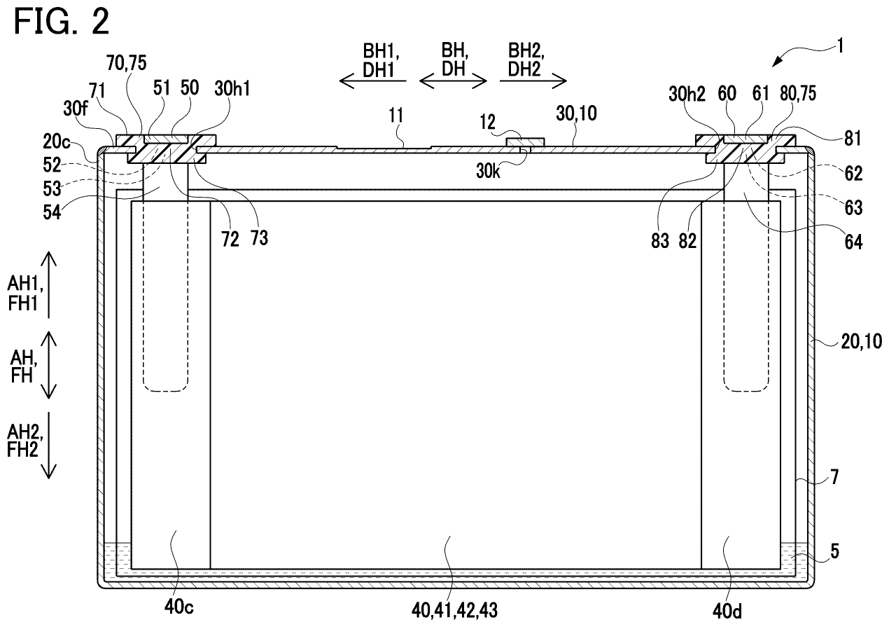

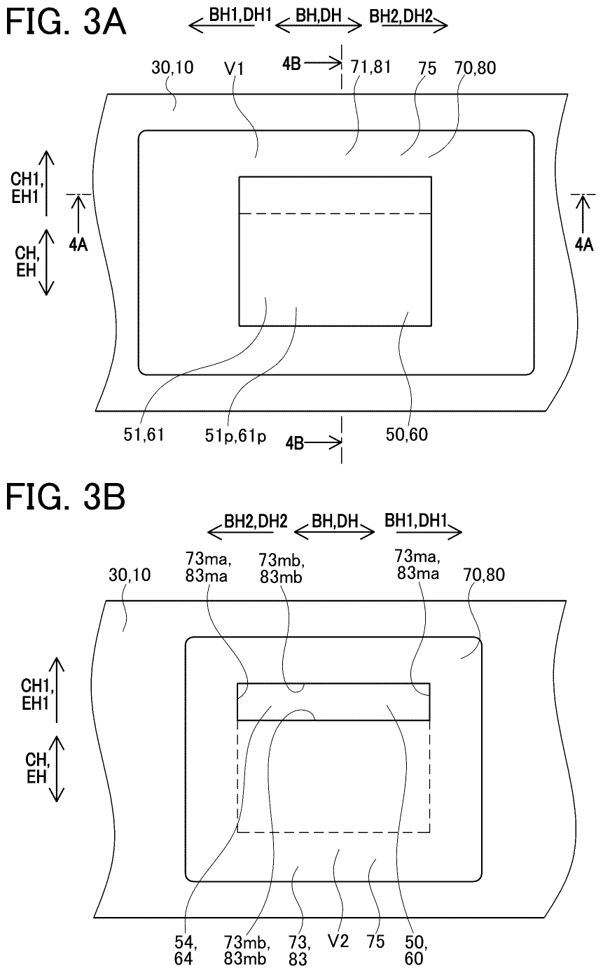

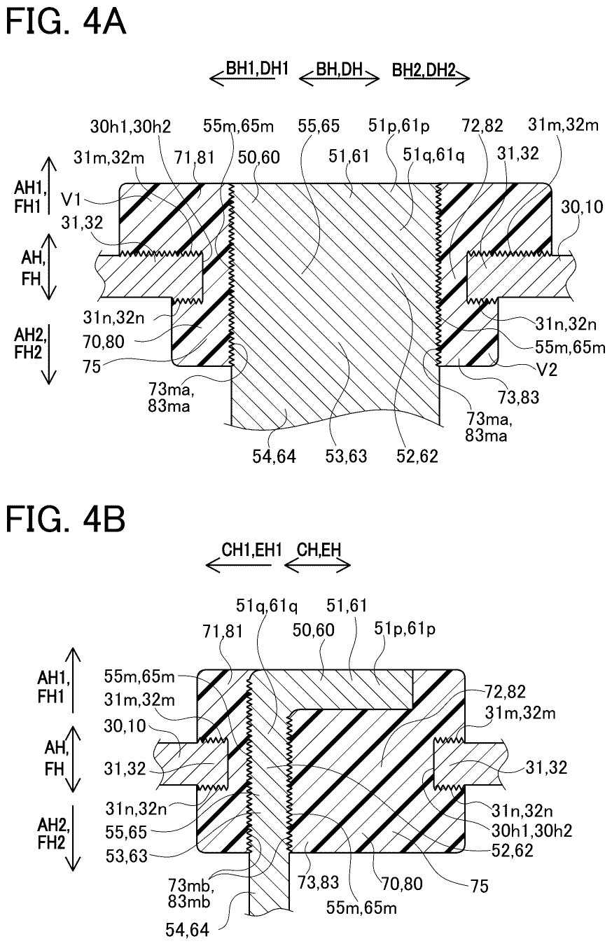

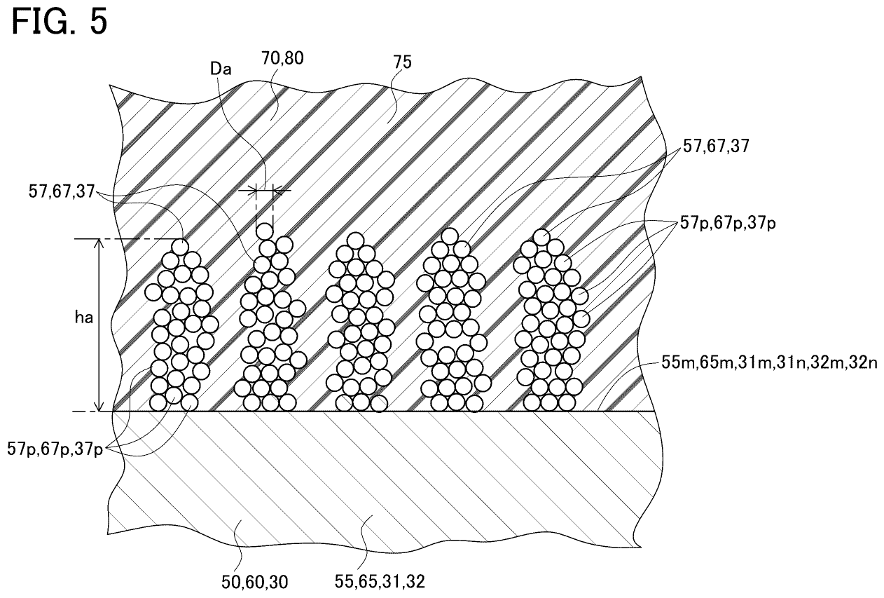

In the following, an embodiment of the disclosure will be described with reference to the accompanying drawings. FIG. 1 is a perspective view of a battery (one example of the power storage device of the disclosure) 1 according to the present embodiment, and FIG. 2 is a partially broken cross-sectional view of the battery 1. FIG. 3A and FIG. 3B are partially enlarged plan views and FIG. 4A and FIG. 4B are partially enlarged cross-sectional views of a resin member 70, 80 fixing a terminal member 50, 60 to a case lid member 30 and its vicinity. Further, FIG. 5 is a partially enlarged cross-sectional view of terminal nanocolumns 57, 67 standing numerously on a surface 55m, 65m of a terminal seal portion 55, 65, and others. Herein, in the following description, a battery height direction AH, a battery width direction BH, and a battery thickness direction CH of the battery 1 and a lid longitudinal direction DH, a lid transverse direction EH, and a lid thickness direction FH of the case lid member 30 are defined as the directions indicated in FIG. 1 to FIG. 4B.

The battery 1 is a sealed lithium-ion secondary battery having a rectangular (rectangular parallelepiped) shape, which is installed on a vehicle such as a hybrid vehicle, a plug-in hybrid vehicle, or an electric vehicle. The battery 1 consists of a case 10, an electrode body 40 housed in the case 10, a terminal member 50 of a positive electrode fixed to the case 10 via a resin member 70, a terminal member 60 of a negative electrode fixed to the case 10 via a resin member 80, and so forth. In the case 10, the electrode body 40 is covered with a bag-like insulating holder 7 made from an insulating film. The case 10 also contains electrolyte 5, and the electrode body 40 is impregnated with a part of the electrolyte 5, while the rest of the electrolyte 5 is collected and kept on a bottom wall of the case 10.

The case 10 is shaped like a rectangular parallelepiped box and made of metal (aluminum in this embodiment). The case 10 consists of a case body 20 that is in the shape of a rectangular tube with a bottom and a rectangular opening portion 20c and houses the electrode body 40 therein, and a case lid member 30 in the shape of a rectangular plate that closes the opening portion 20c of the case body 20. The opening portion 20c of the case body 20 and a peripheral portion 30f of the case lid member 30 are hermetically welded together over the entire circumference thereof.

The case lid member 30 of the case 10 is provided with a safety valve 11 that breaks and opens when the internal pressure of the case 10 exceeds the valve opening pressure. The case lid member 30 is also provided with a liquid inlet 30k that extends through the case lid member 30 in the lid thickness direction FH, and the liquid inlet 30k is hermetically sealed with a disc-shaped sealing member 12 made of aluminum.

The electrode body 40 housed in the case 10 is of a rectangular parallelepiped, stacked type, and has a plurality of positive electrode sheets 41 and a plurality of negative electrode sheets 42 alternately stacked in the battery thickness direction CH via separators 43 each made from a porous resin film. Each of the positive electrode sheets 41, negative electrode sheets 42, and separators 43 has a rectangular shape extending in the battery height direction AH and the battery width direction BH.

Each of the positive electrode sheets 41 consists of a positive current collecting foil made from an aluminum foil, and positive active material layers including positive active material particles and respectively formed on both main surfaces of the positive current collecting foil. A part of the positive current collecting foil extends to one side BH1 in the battery width direction BH and provides a positive-electrode foil exposed portion that is exposed without the positive active material layers present on both main surfaces of the positive current collecting foil. The positive-electrode foil exposed portions of the respective positive electrode sheets 41 are stacked in the foil thickness direction to form a positive current collector 40c. The positive current collector 40c is conductively connected to a terminal member 50 of the positive electrode which will be described below.

Each of the negative electrode sheets 42 consists of a negative current collecting foil made from a copper foil, and negative active material layers including negative active material particles and respectively formed on both main surfaces of the negative current collecting foil. A part of the negative current collecting foil extends to the other side BH2 in the battery width direction BH and provides a negative-electrode foil exposed portion that is exposed without the negative active material layers present on both main surfaces of the negative current collecting foil. The negative-electrode foil exposed portions of the respective negative electrode sheets 42 are stacked in the foil thickness direction to form a negative current collector 40d. The negative current collector 40d is conductively connected to the terminal member 60 of the negative electrode which will be described below.

Portions of the case lid member 30 near its ends on one side DH1 and the other side DH2 in the lid longitudinal direction DH (one side BH1 and the other side BH2 in the battery width direction BH) respectively have rectangular insertion holes 30h1, 30h2 extending through the case lid member 30 in the lid thickness direction FH. The terminal member 50 of the positive electrode made of aluminum is inserted through the one insertion hole 30h1, and the terminal member 50 is fixed to the case lid member 30 while being insulated from the case lid member 30 via the resin member 70. Also, the terminal member 60 of the negative electrode made of copper is inserted through the other insertion hole 30h2, and the terminal member 60 is fixed to the case lid member 30 while being insulated from the case lid member 30 via the resin member 80.

Next, the resin member 70, 80 will be explained. The resin member 70, 80 is joined to the case lid member 30 and the terminal member 50,60 and fixes the terminal member 50, 60 to the case lid member 30 while insulating the case lid member 30 and the terminal member 50, 60 from each other. More specifically, the resin member 70, 80 is hermetically joined to the terminal seal portion 55, 65 such that gaps between the numerously standing terminal nanocolumns 57, 67 of the terminal seal portion 55, 65 of the terminal member 50, 60 are filled with the resin material 75 described below (see FIG. 5). The resin member 70, 80 is also hermetically joined to the lid seal portion 31, 32 such that gaps between the numerously standing lid nanocolumns 37 of the lid seal portion 31, 32 of the case lid member 30 are filled with the resin material 75.

The resin member 70, 80 consists of a resin outer portion 71, 81, a resin inner portion 73, 83, and a resin inside-hole portion 72, 82 positioned between the resin outer portion 71, 81 and the resin inner portion 73, 83 to be integrally connected to (in other words, to be integrally formed with) the resin outer portion 71, 81 and the resin inner portion 73, 83. The resin outer portion 71, 81 is a portion located on the outer side FH1 in the lid thickness direction FH (the upper side AH1 in the battery height direction AH) of the case lid member 30. The resin inner portion 73, 83 is a portion located on the inner side FH2 in the lid thickness direction FH (the lower side AH2 in the battery height direction AH) of the case lid member 30. This resin inner portion 73, 83 includes a pair of longitudinal joint faces 73ma, 83ma that face the lid longitudinal direction DH (the battery width direction BH), namely, a surface normal of the respective joint faces is aligned with the lid longitudinal direction DH, and that is joined to the terminal member 50, 60. Further, and the resin inner portion 73, 83 includes a pair of transverse joint faces 73mb, 83mb that face the lid transverse direction EH (the battery thickness direction CH), namely, a surface normal of the respective joint faces is aligned with the lid transverse direction EH, and that is joined to the terminal member 50, 60. Further, the resin inside-hole portion 72, 82 is a portion located inside a hole of the insertion hole 30h1, 30h2 of the case lid member 30. In the present embodiment, a volume V1 of the resin outer portion 71, 81 is larger than a volume V2 of the resin inner portion 73, 83 (V1>V2). Specifically, the volume V1 of the resin outer portion 71, 81 is about 1.5 times as large as the volume V2 of the resin inner portion 73, 83.

The resin member 70, 80 is made of the resin material 75 including a thermoplastic main resin, a thermoplastic elastomer, and a filler. In the present embodiment, the main resin is polyphenylene sulfide (PPS), the elastomer is a thermoplastic polyurethane elastomer, and the filler is a glass filler that is fibrous (generally, 10 μm in diameter×300 μm in length). Further, a linear expansion coefficient α1 of the resin material 75 in a temperature range of −40° C. to 65° C. is represented as α1=2.0×10⁻⁵ (1/K). The case lid member 30 is made of aluminum as mentioned above, and the linear expansion coefficient α2 in the temperature range of −40° C. to 65° C. is represented as α2=2.4×10⁻⁵ (1/K), so that the linear expansion coefficient α2 of the metal (aluminum) forming the case lid member 30 is made larger than the linear expansion coefficient α1 of the resin material 75 forming the resin member 70, 80.

The terminal member 50, 60 is now explained. The terminal member 50, 60 is formed by pressing a metal plate, specifically, an aluminum plate is used for the positive electrode and a copper plate is used for the negative electrode. The terminal member 50, 60 extends through the resin outer portion 71, 81, the resin inside-hole portion 72, 82, and the resin inner portion 72, 83 of the resin member 70, 80 to the inner side FH2 (the lower side AH2) in the lid thickness direction FH. The terminal member 50, 60 is formed of a terminal outer portion 51, 61, a terminal inside-hole portion 52, 62, a terminal inner portion 53, 63, and a terminal extended portion 54, 64.

The terminal outer portion 51, 61 is located on an outer side FH1 in the lid thickness direction FH of the case lid member 30 and joined to the resin outer portion 71, 81 of the resin member 70, 80. The terminal outer portion 51, 61 is formed of a rectangular plate-like top portion 51p, 61p expanding in the lid longitudinal direction DH and the lid transverse direction EH and an extended portion 51q, 61q bent at an end portion on the one side EH1 in the lid transverse direction EH (on the one side CH1 in the battery thickness direction CH) of the top portion 51p, 61p and extending to the inner side FH2 in the lid thickness direction FH.

The terminal inside-hole portion 52, 62 is located inside the hole of the insertion hole 30h1, 30h2 of the case lid member 30 to be joined to the resin inside-hole portion 72, 82 of the resin member 70, 80.

The terminal inner portion 53, 63 is located on the inner side FH2 in the lid thickness direction FH in the case lid member 30 to be joined to the resin inner portion 73, 83 of the resin member 70, 80. Specifically, to the terminal inner portion 53, 63, the pair of the longitudinal joint faces 73ma, 83ma of the resin inner portion 73, 83 are joined with respect to the lid longitudinal direction DH, and the pair of the transverse joint faces 73mb, 83mb of the resin inner portion 73, 83 are joined with respect to the lid transverse direction EH.

The terminal extended portion 54, 64 further extends to the lower side AH2 from the terminal inner portion 53, 63 to protrude to the lower side AH2 from the resin member 70, 80. The terminal extended portion 54 of the positive electrode is welded to the positive current collector 40c of the electrode body 40 on a leading end on the lower side AH2 and conductively connected to the positive current collector 40c. The terminal extended portion 64 of the negative electrode is welded to the negative current collector 40d of the electrode body 40 on the leading end of the lower side AH2 and conductively connected to the negative current collector 40d.

In the present embodiment, in the terminal member 50, 60, the extended portion 51q, 61q of the terminal outer portion 51, 61, the terminal inside-hole portion 52, 62, and the terminal inner portion 53, 63 constitute the terminal seal portion 55, 65 to which the resin member 70, 80 is hermetically joined. On the surface 55m 65m of the terminal seal portion 55, 65 (specifically a surface of the extended portion 51q, 61q of the terminal outer portion 51, 61, a surface of the terminal inside-hole portion 52, 62, and a surface of the terminal inner portion 53, 63), as shown in FIG. 5, particles 57p, 67p derived from metal (aluminum on the positive electrode and copper on the negative electrode) that forms the terminal member 50, 60 are joined together like strings of beads, into the form of columns, so that the terminal nanocolumns 57, 67 stand together in large numbers.

More specifically, the terminal nanocolumns 57 of the positive electrode consist of the particles 57p made of aluminum and aluminum oxide, and the terminal nanocolumns 67 of the negative electrode consist of the particles 67p made of copper and copper oxide. The diameter Da of each particle 57p, 67p is equal to or smaller than 100 nm (Da is equal to about 30 nm in the embodiment), and the height ha of the terminal nanocolumn 57, 67 is equal to or larger than 50 nm (ha is equal to about 500 nm in the embodiment). Gaps between the numerously standing terminal nanocolumns 57, 67 are filled with the resin material 75, so that the resin member 70, 80 is hermetically joined to the terminal seal portion 55, 65.

The resin member 70, 80 is also hermetically joined to a lid seal portion 31, 32 of the case lid member 30 which surrounds the insertion hole 30h1, 30h2 (see FIG. 4A and FIG. 4B). Specifically, the lid seal portion 31, 32 has a rectangular band-like outer surface 31m, 32m that faces to the outer side FH1 in the lid thickness direction FH (to the upper side AH1) and a rectangular band-like inner surface 31n, 32n that faces to the inner side FH2 in the lid thickness direction FH (to the lower side AH2). On these surfaces 31m, 32m, 31n, 32n, like the surface 55m of the terminal seal portion 55 of the positive electrode (see FIG. 5), the lid nanocolumns 37 formed by joining particles 37p made of aluminum and aluminum oxide together like strings of beads stand together in large numbers. The diameter Da of each particle 37p is equal to or smaller than 100 nm (Da is equal to about 30 nm in the embodiment), and the height ha of the lid nanocolumns 37 is equal to or larger than 50 nm, further equal to or larger than 300 nm (ha is equal to about 500 nm in the embodiment). Gaps between the numerously standing lid nanocolumns 37 are filled with the resin material 75, so that the resin member 70, 80 is hermetically joined to the lid seal portion 31, 32.

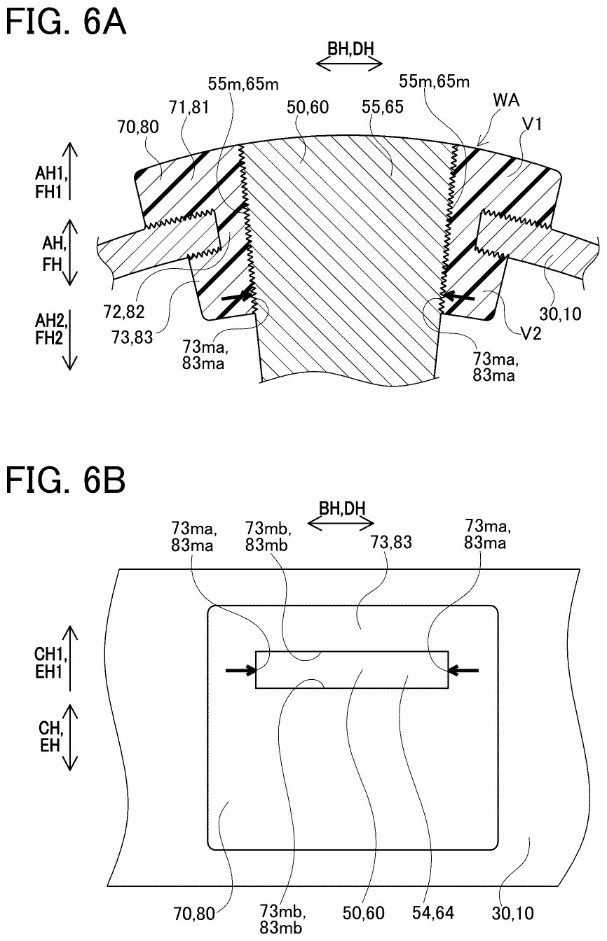

In the battery 1 of the present embodiment, the case lid member 30 and the resin member 70, 80 are configured as described below. Specifically, when the battery 1 is placed under a temperature environment of −40° C. (see FIG. 6A and FIG. 6B), a convex warp WA is formed on the outer side FH1 in the lid thickness direction FH with respect to the lid longitudinal direction DH. Then, the pair of longitudinal joint faces 73ma, 83ma of the resin inner portion 73, 83 of the resin member 70, 80 are configured to press the terminal member 50, 60 respectively in the lid longitudinal direction DH.

The reason why the convex warp WA is formed on the outer side FH1 in the resin member 70, 80 is considered as below. In the present embodiment, the linear expansion coefficient α2 of the metal (aluminum) forming the case lid member 30 is made larger than the linear expansion coefficient α1 of the resin material 75 forming the resin member 70, 80. Accordingly, when the battery 1 is placed under the temperature environment of −40° C., the case lid member 30 is contracted more largely than the resin member 70, 80 in the lid longitudinal direction DH. On the other hand, the resin member 70, 80 and the case lid member 30 are joined to each other, and thus the resin member 70, 80 and the case lid member 30 are curvedly deformed due to this thermal contraction differences like deformation of bimetal. In the resin member 70, 80, the volume V1 of the resin outer portion 71, 81 is larger than the volume V2 of the resin inner portion 73, 83, so that the resin outer portion 71, 81 has much more influence than the resin inner portion 73, 83, which is considered to cause the convex warp WA in the resin member 70, 80 and the case lid member 30 on the outer side FH1.

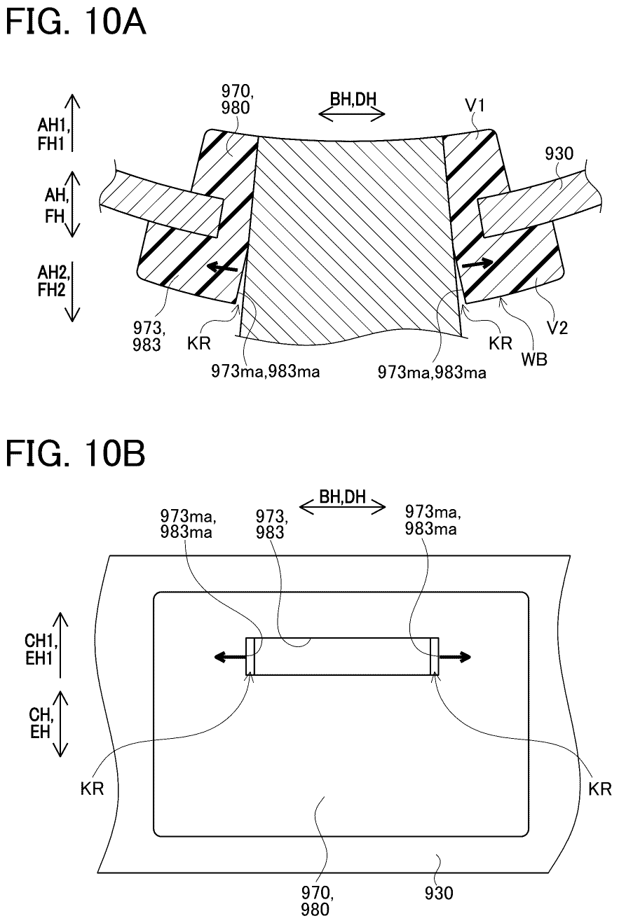

Herein, a configuration of a case lid member 930 and a resin member 970, 980 of a battery according to a comparative embodiment is explained (see FIG. 10A and FIG. 10B). When the battery of the comparative embodiment is placed under the temperature environment of −40° C., as contrary to the battery 1 of the present embodiment, a convex warp WB is formed on the resin member 970, 980 on the inner side FH2 of the lid thickness direction FH (to the lower side AH2) with respect to the lid longitudinal direction DH. When this convex warp WB is formed on the inner side FH2 in the lid thickness direction FH (the lower side AH2), a resin inner portion 973, 983 is deformed toward a direction away from a terminal member 950, 960 with respect to the lid longitudinal direction DH, so that each portion of a pair of longitudinal joint faces 973ma, 983ma causes cohesive failure, resulting in cracks KR.

On the contrary, in the battery 1 of the present embodiment, the convex warp WA is formed in the resin member 70, 80 on the outer side FH1 at the low temperature of −40° C. as mentioned above. Then, the pair of the longitudinal joint faces 73ma, 83ma of the resin inner portion 73, 83 of the resin member 70, 80 respectively press the terminal member 50, 60 in the lid longitudinal direction DH. Accordingly, formation of the cohesive failure and generation of the cracks KR in the vicinity of the pair of the longitudinal joint faces 73ma, 83ma of the resin inner portion 73, 83 can be inhibited. Therefore, even when the battery 1 is placed at the low temperature of −40° C., the battery 1 hardly forms the cracks KR in the vicinity of the pair of the longitudinal joint faces 73ma, 83ma of the resin inner portion 73, 83 of the resin member 70, 80.

Further in the present embodiment, the volume V1 of the resin outer portion 71, 81 of the resin member 70, 80 is made larger than the volume V2 of the resin inner portion 73, 83 (V1>V2), and thus the battery 1, in which the resin member 70, 80 forms the convex warp WA on the outer side FH1 at the low temperature of −40° C., can be easily configured.

Further, in the present embodiment, the terminal nanocolumns 57, 67 are standing numerously on the surface 55m, 65m of the terminal seal portion 55, 65 of the terminal member 50, 60, and the gaps between these terminal nanocolumns 57, 67 are filled with the resin material 75, so that the resin member 70, 80 is hermetically joined to the terminal seal portion 55, 65. Accordingly, the joint strength of the terminal seal portion 55, 65 of the terminal member 50, 60 and the resin member 70, 80 can be increased, thereby retaining preferable sealing performance of the terminal member 50, 60 with the resin member 70, 80.

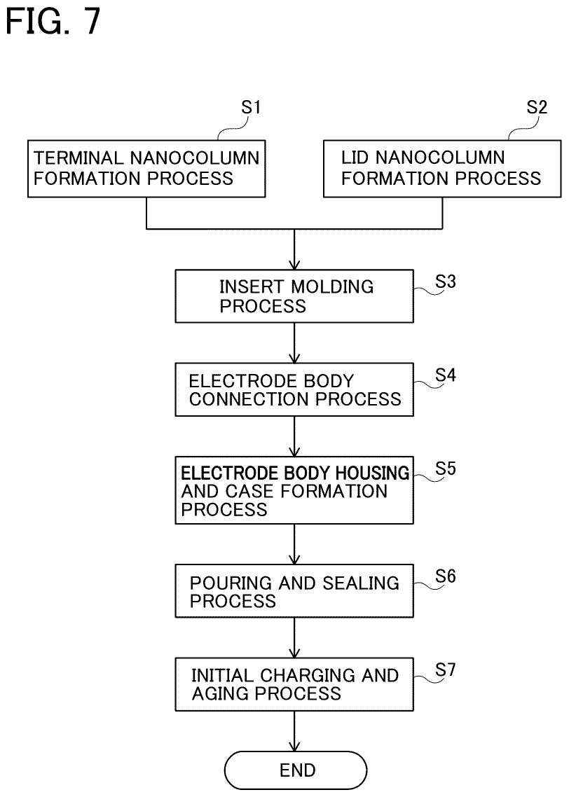

Next, a method of manufacturing the battery 1 will be described (see FIG. 7 to FIG. 9B). First, a case lid member 30Z before roughening is prepared. The case lid member 30Z before roughening is obtained by punching an aluminum plate into a predetermined shape and forming the liquid inlet 30k, the insertion holes 30h1, 30h2, and the safety valve 11 in it. Terminal members 50Z, 60Z before roughening are also prepared. The terminal member 50Z of the positive electrode before roughening is obtained by punching an aluminum plate into a predetermined shape and bending it. The terminal member 60Z of the negative electrode before roughening is obtained by punching a copper plate into a predetermined shape and bending it.

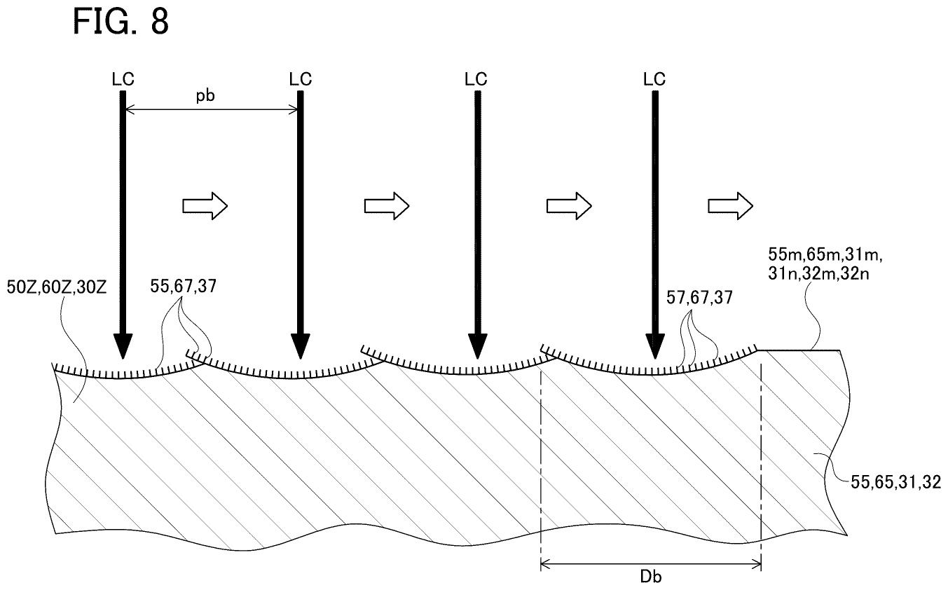

Then, in “terminal nanocolumn formation process S1” (see FIG. 7), a pulse oscillation laser beam LC is applied to the terminal seal portion 55, 65 of the terminal member 50Z, 60Z while shifting the irradiation position (see FIG. 8) to form the numerously standing terminal nanocolumns 57, 67 on the surface 55m, 65m of the terminal seal portion 55, 65. As described above (see also FIG. 5), the terminal nanocolumns 57, 67 are formed by joining the particles 57p, 67p together like strings of beads into the form of columns.

In the present embodiment, the irradiation conditions of the laser beam for the positive electrode are set as follows: the wavelength is 1064 nm, the peak power is 5 kW, the pulse width is 150 ns, the pitch pb is 75 μm, and the spot diameter Db is 80 μm. The irradiation conditions of the laser beam for the negative electrode are set at follows: the wavelength is 1064 nm, the peak power is 20 kW, the pulse width is 50 ns, the pitch pb is 60 μm, and the spot diameter Db is 75 μm. In each of the terminal seal portions 55, 65, metal (aluminum on the positive electrode, copper on the negative electrode) near the surface 55m 65m is melted in a circular region as seen in plan view which is irradiated with the laser beam LC, and further turns into vapor. As the temperature of the vapor then decreases, the vapor turns into the particles 57p, 57p (the particles 57p of aluminum and aluminum oxide on the positive electrode, the particles 67p of copper and copper oxide on the negative electrode), which are deposited on the surface 55m, 65m of the terminal seal portion 55, 65. By applying the laser beam LC to the terminal seal portion 55, 65 while shifting the irradiation position, the particles 57p, 67p are deposited and joined together like strings of beads into the form of columns to form the terminal nanocolumns 57, 67 standing together in large numbers.

Meanwhile, in “lid nanocolumn formation process S2” (see FIG. 7), a pulse oscillation laser beam LC is applied to the lid seal portion 31, 32 of the case lid member 30Z while shifting the irradiation position (see FIG. 8) to form the numerously standing lid nanocolumns 37 on the outer surface 31m, 32m and the inner surface 31n, 32n of the lid seal portion 31, 32. As described above (see also FIG. 5), the lid nanocolumns 37 are formed by joining the particles 37p made of aluminum and aluminum oxide together like strings of beads into the form of columns. In the present embodiment, the laser irradiation conditions are substantially identical with those under which the terminal nanocolumns 57 are formed on the terminal seal portion 55 of the positive electrode in the terminal nanocolumn formation process S1.

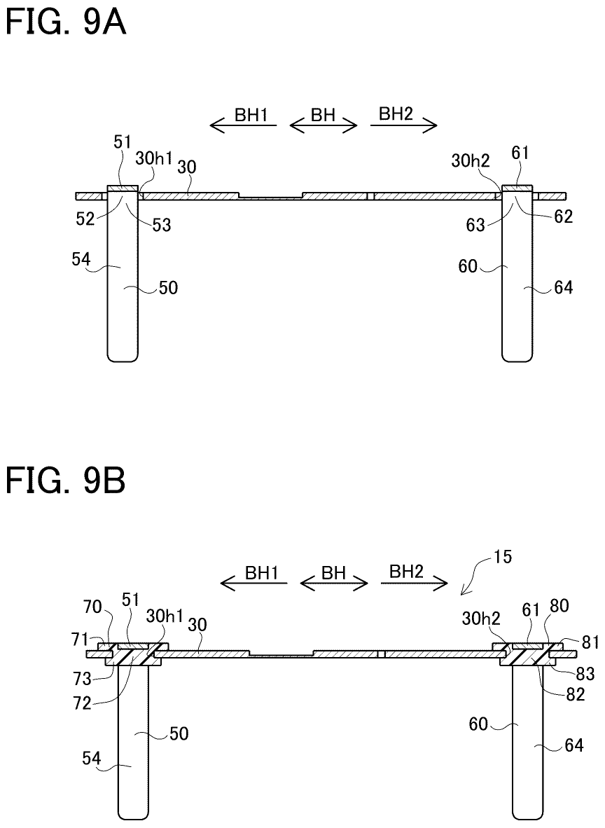

Next, in “insert molding process S3” (see FIG. 7), in a condition where the terminal member 50, 60 is inserted through the insertion hole 30h1, 30h2 of the case lid member 30, the resin member 70, 80 is formed by insert molding (see FIG. 9A and FIG. 9B), using the above-mentioned resin material 75. More specifically, the insert molding process S3 is carried out using a molding die (not shown) having an upper die and a lower die. First, the case lid member 30 is placed at a predetermined position of the lower die, and the terminal members 50, 60 are respectively inserted through the insertion holes 30h1, 30h2 of the case lid member 30 (see FIG. 9A). Then, the upper die is moved toward the lower die to close the molding die.

The molten resin material 75 is then injected into cavities of the molding die. At this time, the resin material 75 fills gaps between the numerously standing terminal nanocolumn 57, 67 of the terminal seal portion 55, 65 and gaps between the numerously standing lid nanocolumns 37 of the lid seal portion 31, 32 to form the resin member 70, 80 hermetically joined to the terminal seal portion 55, 65 and the lid seal portion 31, 32 (see FIG. 9B). Each of the cavities of the molding die is formed such that the volume V1 of the resin outer portion 71, 81 is larger than the volume V2 of the resin inner portion 73, 83, and thus the resin member 70, 80 is configured in a manner that the volume V1 of the resin outer portion 71, 81 is larger than the volume V2 of the resin inner portion 73, 83. Then, a lid assembly 15 with the terminal members 50, 60 fixed to the case lid member 30 via the resin member 70, 80 is removed from the molding die.

Next, in “electrode body connection process S4” (see FIG. 7), the electrode body 40 obtained by stacking the positive electrode sheets 41, negative electrode sheets 42, and separators 43 is prepared, and the terminal extended portion 54 of the terminal member 50 of the positive electrode as a part of the lid assembly 15 described above is welded to the positive current collector 40c of the electrode body 40. The terminal extended portion 64 of the terminal member 60 of the negative electrode as a part of the lid assembly 15 is also welded to the negative current collector 40d of the electrode body 40. The electrode body 40 is then wrapped with the bag-like insulating holder 7.

Next, in “electrode body housing and case formation process S5”, the case body 20 is prepared, the electrode body 40 covered with the insulating holder 7 described above is inserted into the case body 20, and the opening portion 20c of the case body 20 is closed with the case lid member 30. Then, the opening portion 20c of the case body 20 and the peripheral portion 30f of the case lid member 30 are laser welded hermetically over the entire circumference to form the case 10 with the electrode body 40 housed inside.

Next, in “pouring and sealing process S6”, the electrolyte 5 is poured into the case 10 through the liquid inlet 30k, so that the electrode body 40 is impregnated with the electrolyte 5. The liquid inlet 30k is then covered from the outside with the sealing member 12, and the sealing member 12 is laser welded hermetically to the case 10.

Next, in “initial charging and aging process S7”, a charging device (not shown) is connected to the battery 1 to perform initial charging on the battery 1. Then, the initially charged battery 1 is left to stand for a predetermined time so that the battery 1 is aged. In this manner, the battery 1 is completed.

As explained above, in the method of manufacturing the battery 1, the resin member 70, 80 is insert molded in the insert molding process S3, and thus the battery 1 in which the resin member 70, 80 has the convex warp WA on the outer side FH1 at the low temperature of −40° C. can be easily manufactured.

Further in the present embodiment, the resin member 70, 80 is configured such that the volume V1 of the resin outer portion 71, 81 is larger than the volume V2 of the resin inner portion 73, 83, and thus the battery 1, in which the resin member 70, 80 has the convex warp WA on the outer side FH1 at the low temperature of −40° C., can be easily manufactured.

Furthermore, in the terminal nanocolumn formation process S1, the terminal nanocolumns 57, 67 are formed on the surface 55m, 65m of the terminal seal portion 55, 65 by irradiating the surface 55m, 65m with the laser beam LC, so that the terminal nanocolumns 57, 67 can be easily formed on the terminal seal portion 55, 65. Since the resin member 70, 80 is molded with the resin material 75 filling gaps between the terminal nanocolumns 57, 67 in the insert molding process S3, the joint strength of the terminal seal portion 55, 65 of the terminal member 50, 60 and the resin member 70, 80 can be increased, and good seals between the terminal member 50, 60 and the resin member 70, 80 can be maintained.

While the disclosure has been described in the light of the embodiment, it is to be understood that the disclosure is not limited to the embodiment, but may be applied by making changes as needed, without departing from the principle of the disclosure.

### REFERENCE SIGNS LIST

1 Battery (Power storage device)
10 Case
30 Case lid member
30h1,30h2 Insertion hole
40 Electrode body
50,60 Terminal member
55,65 Terminal seal portion
55m,65m Surface (of the terminal seal portion)
57,67 Terminal nanocolumn
57p,67p Particles
70,80 Resin member
71,81 Resin outer portion
72,82 Resin inside-hole portion
73,83 Resin inner portion
73ma,83ma Longitudinal joint face
73mb,83mb Transverse joint face
DH Lid longitudinal direction
EH Lid transverse direction
FH Lid thickness direction
FH1 Outer side (in the lid thickness direction)
FH2 Inner side (in the lid thickness direction)
V1 Volume (of the resin outer portion)
V2 Volume (of the resin inner portion)
WA Warp (of an outward convex shape in the lid thickness direction with respect to the lid longitudinal direction)
WB Warp (of an inward convex shape in the lid thickness direction with respect to the lid longitudinal direction)
KR Cracks
LC Laser beam
S1 Terminal nanocolumn formation process
S3 Insert molding process

What is claimed is:

1. A power storage device comprising:
a case lid member having an insertion hole and extending in a lid longitudinal direction;
a terminal member inserted through the insertion hole of the case lid member; and
a resin member hermetically joined to the case lid member and the terminal member while insulating the case lid member and the terminal member from each other, to fix the terminal member to the case lid member, wherein
the resin member comprises:
a resin outer portion located on an outer side in a lid thickness direction of the case lid member;
a resin inner portion located on an inner side in the lid thickness direction of the case lid member, and
a resin inside-hole portion located inside the insertion hole of the case lid member and integrally connected to the resin outer portion and the resin inner portion,
the terminal member extends to an inner side in the lid thickness direction through the resin outer portion, the resin inside-hole portion, and the resin inner portion,
the resin inner portion of the resin member includes a pair of longitudinal joint faces that face the lid longitudinal direction and is joined to the terminal member,
the case lid member and the resin member are configured that, when the power storage device is placed under a temperature environment of −40° C., an outward convex warp in the lid thickness direction is formed in the resin member with respect to the lid longitudinal direction, and
the pair of the longitudinal joint faces of the resin inner portion press the terminal member in the lid longitudinal direction, respectively.

2. The power storage device according to claim 1, wherein the resin member has a volume V1 of the resin outer portion larger than a volume V2 of the resin inner portion (V1>V2).

3. The power storage device according to claim 1, wherein
the terminal member includes a terminal seal portion to which the resin member is hermetically joined, and terminal nanocolumns with a height of 50 nm or more derived from metal that forms the terminal member and formed by joining particles of a diameter of 100 nm or less, together like strings of beads into the form of columns, stand numerously on a surface of the terminal seal portion, and
the resin member is hermetically joined to the terminal seal portion with the resin material, which forms the resin member and fills gaps between the terminal nanocolumns standing numerously.

4. A method of manufacturing a power storage device comprising:
a case lid member having an insertion hole and extending in a lid longitudinal direction;
a terminal member inserted through the insertion hole of the case lid member; and
a resin member hermetically joined to the case lid member and the terminal member while insulating the case lid member and the terminal member from each other, to fix the terminal member to the case lid member, wherein
the resin member comprises:
a resin outer portion located on an outer side in a lid thickness direction of the case lid member;
a resin inner portion located on an inner side in the lid thickness direction of the case lid member; and
a resin inside-hole portion located inside the insertion hole of the case lid member and integrally connected to the resin outer portion and the resin inner portion, wherein
the terminal member extends to an inner side in the lid thickness direction through the resin outer portion, the resin inside-hole portion, and the resin inner portion,
the resin inner portion of the resin member includes a pair of longitudinal joint faces that face the lid longitudinal direction and are joined to the terminal member,
the case lid member and the resin member are configured that, when the power storage device is placed under a temperature environment of −40° C., an outward convex warp in the lid thickness direction is formed with respect to the lid longitudinal direction in the resin member, and
the pair of the longitudinal joint faces of the resin inner portion press the terminal member in the lid longitudinal direction, respectively, wherein
the method includes insert molding the resin member while the terminal member is inserted through the insertion hole of the case lid member.

5. The method of manufacturing the power storage device according to claim 4, wherein the insert molding is to mold the resin member in which a volume V1 of the resin outer portion is larger than a volume V2 of the resin inner portion (V1>V2).

6. The method of manufacturing the power storage device according to claim 4, wherein
the terminal member includes a terminal seal portion to which the resin member is hermetically joined, and terminal nanocolumns with a height of 50 nm or more derived from metal that forms the terminal member and formed by joining particles of a diameter of 100 nm or less, together like strings of beads into the form of columns, stand numerously on a surface of the terminal seal portion, and
the resin member is hermetically joined to the terminal seal portion with the resin material, which forms the resin member and fills gaps between the terminal nanocolumns standing numerously,
the method further includes:
terminal nanocolumn forming of applying a pulse oscillation laser beam to the terminal seal portion of the terminal member while shifting an irradiation position, to form the terminal nanocolumns standing numerously on the terminal seal portion before the insert molding, wherein
the insert molding comprises molding the resin member while filling gaps between the terminal nanocolumns standing numerously on the terminal seal portion with the resin material.

7. The power storage device according to claim 2, wherein
the terminal member includes a terminal seal portion to which the resin member is hermetically joined, and terminal nanocolumns with a height of 50 nm or more derived from metal that forms the terminal member and formed by joining particles of a diameter of 100 nm or less, together like strings of beads into the form of columns, stand numerously on a surface of the terminal seal portion, and
the resin member is hermetically joined to the terminal seal portion with the resin material, which forms the resin member and fills gaps between the terminal nanocolumns standing numerously.

8. The method of manufacturing the power storage device according to claim 5, wherein
the terminal member includes a terminal seal portion to which the resin member is hermetically joined, and terminal nanocolumns with a height of 50 nm or more derived from metal that forms the terminal member and formed by joining particles of a diameter of 100 nm or less, together like strings of beads into the form of columns, stand numerously on a surface of the terminal seal portion, and
the resin member is hermetically joined to the terminal seal portion with the resin material, which forms the resin member and fills gaps between the terminal nanocolumns standing numerously,
the method further includes:
terminal nanocolumn forming of applying a pulse oscillation laser beam to the terminal seal portion of the terminal member while shifting an irradiation position, to form the terminal nanocolumns standing numerously on the terminal seal portion before the insert molding, wherein
the insert molding comprises molding the resin member while filling gaps between the terminal nanocolumns standing numerously on the terminal seal portion with the resin material.
